(19) United States
(12) Patent Application Publication
(10) Pub. No.: US 2026/0321131 A1
(43) Pub. Date: Oct. 15, 2026

(54) LOCATION PREDICTION SYSTEM, LOCATION PREDICTION METHOD, PREDICTIVE DATA COLLECTION DEVICE, AND LOCATION PREDICTION DEVICE

(71) Applicant: HONDA MOTOR CO., LTD., Tokyo (JP)

(72) Inventor: Koji Dan, Wako-shi (JP)

(21) Appl. No.: 19/465,701

(22) Filed: Jan. 30, 2026

(30) Foreign Application Priority Data
Mar. 24, 2025 (JP) 2025-048221

(51) Int. Cl. G08G 1/01; G08G 1/052

(52) U.S. Cl. CPC G08G 1/0125; G08G 1/0145; G08G 1/052

(57) ABSTRACT

A location prediction system includes a processor that; acquires movement data of at least one of learning participants; calculates, from the movement data of the learning participant, a behavior profile including a moving route and a transition in speed along the moving route and stores the behavior profile; acquires a current location and speed of a target participant, which is a traffic participant to be monitored; and applies the current location and speed of the target participant to the behavior profile and predicts a future location of the target participant. The processor acquires an attribute value of each of the learning participants with respect to a participant attribute determined in advance for the traffic participant and classifies the learning participants into a plurality of participant groups based on the attribute value and calculates and stores the behavior profile for each of the participant groups.

### INCORPORATION BY REFERENCE

The present application claims priority under 35 U.S.C. §119 to Japanese Patent Application No. 2025-048221 filed on Mar. 24, 2025. The content of the application is incorporated herein by reference in its entirety.

### BACKGROUND OF THE INVENTION

### Field of the Invention

The present invention relates to a location prediction system, a location prediction method, a predictive data collection device, and a location prediction device.

### Description of the Related Art

In recent years, efforts to provide access to sustainable transportation systems that take into account vulnerable groups among traffic participants have become more active. To achieve this, research and development for further improving traffic safety and convenience through research and development relating to safety precaution technology has been focused on.

International Publication No. WO 2018/142527 discloses a method of storing a travel history in which when a plurality of kinds of travel histories with different vehicle passing locations and vehicle speeds are present on the same link such as an approach road to an intersection including a branch to go straight and a right turn, the travel history on the link is sorted into one kind or a plurality of kinds of travel histories based on a predetermined determination condition and stored in a storage device.

Incidentally, the safety precaution technology has a problem that it is necessary to predict a future location of a traffic participant with high accuracy.

To solve the above-described problem, the present application aims to achieve a system that can predict the future position of the traffic participant with high accuracy. This contributes to the development of sustainable transportation systems.

### SUMMARY OF THE INVENTION

A first aspect of the present invention provides a location prediction system including: a learning information acquisition unit that acquires movement data, which is time series data of location and speed, of at least one of learning participants, which is a traffic participant to be learned; a trajectory learning unit that calculates, from the movement data of the learning participant, a behavior profile including a moving route and a transition in speed along the moving route and stores the behavior profile; a target information acquisition unit that acquires a current location and speed of a target participant, which is a traffic participant to be monitored; and a location prediction unit that applies the current location and speed of the target participant to the behavior profile and predicts a future location of the target participant, the learning information acquisition unit being configured to acquire an attribute value of each of the learning participants with respect to a participant attribute determined in advance for the traffic participant, the trajectory learning unit being configured to classify the learning participants into a plurality of participant groups based on the attribute value, and calculate and store the behavior profile for each of the participant groups.

A second aspect of the present invention provides a location prediction method executed by a computer, the method including: a learning information acquisition step of acquiring movement data, which is time series data of location and speed, for at least one of learning participants, which is a traffic participant to be learned; a trajectory learning step of calculating, from the movement data of the learning participant, a behavior profile including a moving route and a transition in speed along the moving route and storing the behavior profile; a target information acquisition step of acquiring a current location and speed of a target participant, which is a traffic participant to be monitored; and a location prediction step of applying the current location and speed of the target participant to the behavior profile and predicting a future location of the target participant, the learning information acquisition step including acquiring an attribute value of each of the learning participants with respect to a participant attribute determined in advance for the traffic participant, the trajectory learning step including classifying the learning participants into a plurality of participant groups based on the attribute value, and calculating and storing the behavior profile for each of the participant groups.

A third aspect of the present invention provides a predictive data collection device including: a learning information acquisition unit that acquires movement data, which is time series data of location and speed, of at least one of learning participants, which is a traffic participant to be learned; and a trajectory learning unit that calculates, from the movement data of the learning participant, a behavior profile including a moving route and a transition in speed along the moving route and stores the behavior profile, the learning information acquisition unit being configured to acquire an attribute value of each of the learning participants with respect to a participant attribute determined in advance for the traffic participant, the trajectory learning unit being configured to classify the learning participants into a plurality of participant groups based on the attribute value, and calculate and store the behavior profile for each of the participant groups.

A fourth aspect of the present invention provides a location prediction device including: a target information acquisition unit that acquires a current location and speed of a target participant, which is a traffic participant to be monitored; and a location prediction unit that uses a behavior profile calculated from time series data of location and speed of at least one of learning participants, which is a traffic participant to be learned, applies the current location and speed of the target participant to the behavior profile, and predicts a future location of the target participant, the behavior profile including a moving route and a transition in speed along the moving route, the behavior profile being created for each participant group of the learning participants classified by an attribute value of a participant attribute determined in advance, the target information acquisition unit being configured to acquire an attribute value of the participant attribute for the target participant, and specify the participant group corresponding to the target participant from the attribute value for the target participant, and the location prediction unit being configured to predict a future location of the target participant using the behavior profile for the participant group corresponding to the target participant.

According to the aspects of the present invention, it is possible to predict the future location of the traffic participant with high accuracy.

### BRIEF DESCRIPTION OF THE DRAWINGS

FIG. 1 is a diagram illustrating a configuration of a location prediction system according to an embodiment of the present invention;

FIG. 2 is a diagram illustrating a configuration of a location prediction device that constitutes a location prediction system;

FIG. 3 is a flowchart illustrating a procedure of a process executed by the predictive data collection device in a location prediction method executed by the location prediction system;

FIG. 4 is a flowchart illustrating a procedure of a process executed by the location prediction device in the location prediction method executed by the location prediction system; and

FIG. 5 is a diagram illustrating an example of a behavior profile.

### DETAILED DESCRIPTION OF THE INVENTION

Hereinafter, an embodiment of the present invention will be described with reference to the drawings.

### 1. Configuration of Location Prediction System

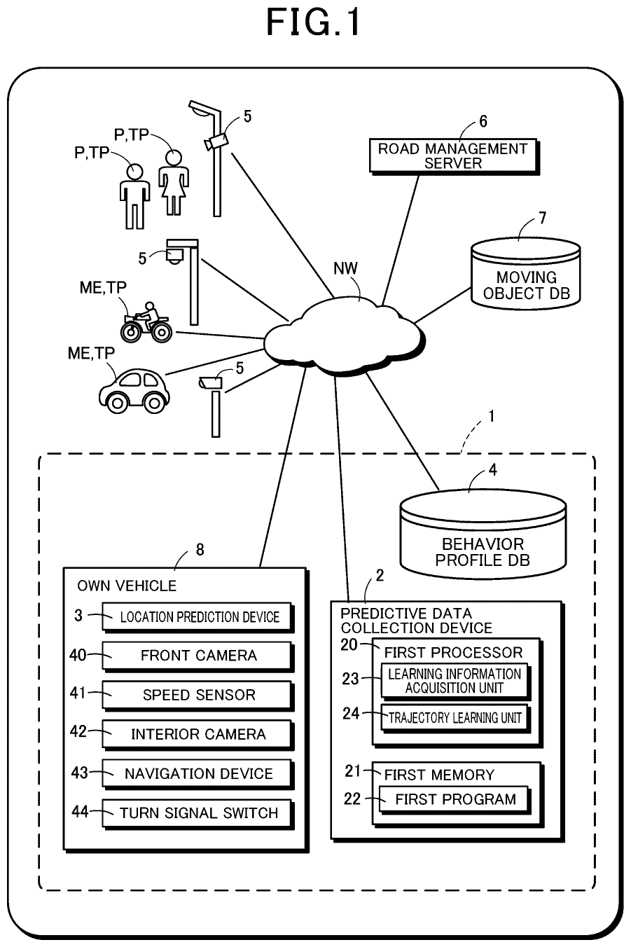

FIG. 1 is a diagram illustrating a configuration of a location prediction system 1 according to an embodiment of the present invention.

The location prediction system 1 learns, as a behavior profile, a trajectory transition and a speed transition of at least one or more traffic participants at points where the traffic participants may undergo some kinds of behavior change, and predicts a future location of the traffic participants using the learned behavior profile.

FIG. 1 is a diagram illustrating an entire configuration of the location prediction system 1.

The location prediction system 1 includes a predictive data collection device 2, a location prediction device 3 mounted on an own vehicle 8, and a behavior profile DB 4 which is a database. The predictive data collection device 2, the location prediction device 3, and the behavior profile DB 4 are communicably connected to one another via a communication network NW. The predictive data collection device 2 generates a behavior profile and stores it in the behavior profile DB 4. The location prediction device 3 acquires the behavior profile stored in the behavior profile DB 4, and predicts a future location of a traffic participant TP using the acquired behavior profile. The traffic participant TP includes, for example, a moving object ME such as an automobile, a motorcycle, or a bicycle, and a person P, and may include the own vehicle 8 as a moving object ME.

The behavior profile DB 4 may be provided in any one or more devices communicably connected to the own vehicle 8 and the predictive data collection device 2 via the communication network NW. Such devices may be a server device connected to the communication network NW, a device mounted on the moving object ME, or a mobile terminal carried by the person P or an occupant of the moving object ME. When the behavior profile DB 4 is provided in a plurality of devices, for example, the predictive data collection device 2 can be configured to update the behavior profile DB 4 provided in each of the devices as appropriate.

The predictive data collection device 2 and the location prediction device 3 are communicably connected to at least one monitoring camera 5, which captures an image of the traffic participant TP, via the communication network NW. The predictive data collection device 2 and the location prediction device 3 may also be communicably connected to the moving object ME, which is the traffic participant TP, via the communication network NW.

The predictive data collection device 2 and the location prediction device 3 may also be communicably connected to a road management server 6 and a moving object DB 7, which is a database, via the communication network NW.

The road management server 6 acquires information regarding a road environment at various places from the monitoring camera 5, a weather information server (not illustrated), or the like, and provides the acquired information. The information regarding the road environment may include information regarding smoothness of traffic flow on the road at each place (for example, information regarding whether there is congestion) and information regarding weather.

The moving object DB 7 stores, in association with each other, a registration number (for example, a vehicle number in a case of a vehicle) of each moving object ME that is a pre-registered traffic participant TP, access information for communicating with the moving object ME, a type of the moving object ME (for example, a motorcycle or a standard-sized car), a classification of a driver (for example, a gender, an age group, or driving experience), and a driver's behavior tendency (for example, speed preference).

The predictive data collection device 2 is implemented, for example, as a server device on the communication network NW.

In the present embodiment, the location prediction device 3 is mounted on the moving object ME. The moving object ME, on which the location prediction device 3 is mounted, is referred to as the own vehicle 8. The moving object ME, which is the own vehicle 8, may not be the moving object ME used as a learning participant (to be described below) when the predictive data collection device 2 generates the behavior profile.

### 2. Configuration of Predictive data Collection Device

The predictive data collection device 2 generates a behavior profile indicating a trajectory transition and a speed transition of the traffic participant TP at points where the traffic participant TP may undergo some kinds of behavior change. The predictive data collection device 2 stores the generated behavior profile in the behavior profile DB 4.

FIG. 1 illustrates an example of a configuration of the predictive data collection device 2.

The predictive data collection device 2 is a computer including a first processor 20 and a first memory 21. The first memory 21 may be configured by, for example, a volatile and/or non-volatile semiconductor memory. The first processor 20 is, for example, an arithmetic processing device such as a CPU. The first processor 20 may include a ROM in which a program is written, a RAM for temporarily storing data, and the like. The first processor 20 includes, as functional elements or functional units, a learning information acquisition unit 23 and a trajectory learning unit 24.

These functional elements of the first processor 20 are implemented when the first processor 20 executes the first program 22 stored in the first memory 21, for example. The first program 22 can be stored in any computer-readable storage medium. Alternatively, all or some of the functional elements of the first processor 20 can be configured by hardware including one or more electronic circuit components.

The learning information acquisition unit 23 acquires movement data, which is time series data of location and speed, for at least one learning participant, which is a traffic participant TP to be learned. The learning information acquisition unit 23 selects, based on images from the monitoring camera 5, at least one or more traffic participants TP at a point where the traffic participant TP may undergo some kinds of behavior change, as learning participants. Hereinafter, the point where the traffic participant TP may undergo some kinds of behavior change is referred to as a behavior change point. Examples of the behavior change point include crossroads, branch roads, pedestrian crossings, places where a temporary stop is required, railroad crossing, and entrances and exits of expressways. The behavior change point may further include a point such as a sloping branch road that can be modified by additional features of the point and expressed. These points may be determined in advance, and information regarding the points (for example, geographical locations and access information to the monitoring camera 5 at the point) may be stored in the predictive data collection device 2.

When the traffic participant TP as a person P is a learning participant, the learning information acquisition unit 23 calculates time series data on location and speed of the learning participant, based on time series images from the monitoring camera 5. In addition, when the traffic participant TP as a moving object ME is a learning participant, the learning information acquisition unit 23 acquires a registration number (for example, a vehicle number) of the moving object ME, which is the learning participant, based on images from the monitoring camera 5, and acquires access information for communicating with the moving object ME from the moving object DB, based on the acquired registration number. The learning information acquisition unit 23 communicates with the moving object ME using the acquired access information, and acquires time series data on location and speed of the moving object ME. Based on techniques of the related art, the moving object ME can transmit time series data on a location detected by a GPS or an inertial measurement device provided in the moving object ME and on a speed obtained by a speed sensor provided in the moving object ME to the predictive data collection device 2.

Alternatively, in a case where the traffic participant TP as a moving object ME is a learning participant, when the learning information acquisition unit 23 cannot communicate with the moving object ME, the learning information acquisition unit 23 may calculate time series data on location and speed of the moving object, based on time series images from the monitoring camera 5.

The learning information acquisition unit 23 also acquires attribute values of each learning participant with respect to participant attributes determined in advance for the traffic participant TP. Information for determining the attribute values of the participant attribute can be acquired from a video from the monitoring camera 5 or from the moving object DB 7, for example.

As an example, the participant attribute includes the type of the traffic participant TP. Examples of attribute values of the participant attribute “type” may include, for example, a “motorcycle”, a “standard-sized car”, a “truck”, a “bus”, a “cyclist”, and a “pedestrian”.

The participant attribute may include the behavior tendency of the traffic participant TP. The behavior tendency of the traffic participant TP may include driving preferences of a driver of the moving object ME or a cyclist, and a behavior tendency of pedestrian's moving behavior. When the traffic participant TP is a moving object ME, the attribute values of the participant attribute “behavior tendency” may be, for example, “speed preference”, “relaxed driving”, “emphasis on driving feel”, “emphasis on safety”, and “tendency to keep in lane”. Furthermore, the attribute values of the participant attribute “behavior tendency” may be, for example, “moving quickly”, “moving slowly”, “difficulty in avoidance behavior”, “distraction”, and “sudden action” when the participant attribute “type” is a “cyclist” or a “pedestrian”.

The participant attribute may include a classification of the traffic participant TP. Examples of attribute values of the participant attribute “classification” may include any one of “male”, “female”, “novice driver”, “driver with intermediate skills”, “advanced driver”, “young group”, “middle-aged group ”, and “old-aged group”, or any contradictable combination thereof.

In addition, the participant attribute may also include details regarding a traffic environment of the place where the traffic participant TP moves. Examples of attribute values of the participant attribute “traffic environment” may include either of “congestion”, “jam”, and “smooth” which indicate the degree of smoothness of the traffic flow, or “cloudlessness”, “strong wind”, “rain”, and “snow” which indicate the weather, or any contradictable combination thereof. Information for determining the attribute values of the participant attribute “traffic environment” may be acquired from images from the monitoring camera 5 or from the road management server 6.

The trajectory learning unit 24 calculates, from the movement data of the learning participant, a behavior profile including a moving route and a transition in speed along the moving route and stores the behavior profile. The behavior profile can be calculated for each combination of the kind of the behavior change point and the content of the behavior change. The combination of the kind of the behavior change point and the content of the behavior change can be, for example, a combination of “crossroads” and “right turn” or a combination of “crossroads” and “go straight”.

In the present embodiment, the trajectory learning unit 24 classifies the learning participants into a plurality of participant groups based on the attribute values, and calculates and stores the behavior profile for each of the participant groups. The participant group can be defined in advance according to a combination of the type of the participant attribute and the attribute value. In addition, the definition of the participant group can be set in various ways depending on a usage method of the behavior profile in the location prediction device 3, which will be described below. For example, assuming usage scenarios in which the attribute values of the participant attribute “behavior tendency” and “classification” cannot be acquired, the participant group defined in advance may include the participant group defined based only on the attribute values of the participant attribute “type”.

In other words, the trajectory learning unit 24 calculates the behavior profile of each of the participant groups for each combination of the kind of the behavior change point and the behavior content. For example, the trajectory learning unit 24 calculates, for each kind of the behavior change point, a behavior profile including an average or representative moving route of the learning participant in each of the participant groups and a transition in average or representative speed along the moving route.

The average or representative moving route can be calculated, as a transition in average value or most frequency value of a relative location within a road width (for example, a distance from one of left and right lines defining the road width) relative to a distance up to the behavior change point. Similarly, the transition in average or representative speed along the moving route can be calculated as, for example, a transition in average value or most frequent value at each point on the moving route.

The trajectory learning unit 24 stores and saves the calculated behavior profile in the behavior profile DB 4 in association with the combination of the kind of the behavior change point and the behavior content, and identification information of the participant group.

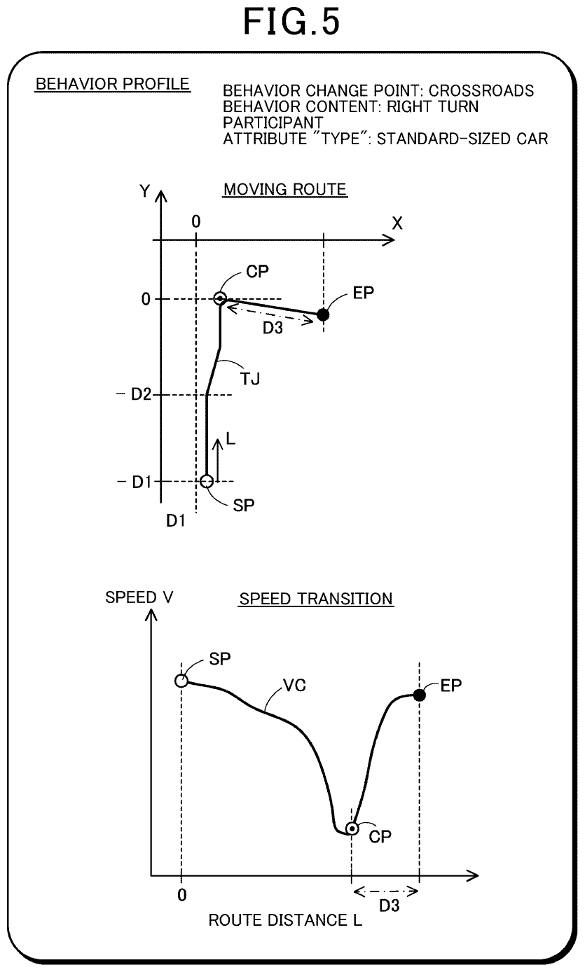

FIG. 5 is a diagram illustrating an example of a behavior profile. As an example, FIG. 5 illustrates a behavior profile for a participant group in which the attribute value of the participant attribute “type” is “standard-sized car” when the behavior content is “right turn” at the behavior change point “crossroads”. The behavior profile is configured by a moving route shown in the upper part of FIG. 5 and a speed transition shown in the lower part of FIG. 5.

The moving route in the upper part of FIG. 5 is expressed on a two-dimensional coordinate system formed with a Y-axis in a direction along a road toward the behavior change point CP and an X-axis orthogonal to the Y-axis. Coordinate values are expressed in kilometers, for example. An origin of the Y-axis is a position of the behavior change point CP, and an origin of the X-axis is a shoulder of the road leading to the behavior change point, on the left side approaching the behavior change point. A curve shown in the upper part of FIG. 5 is a moving route TJ.

The moving route TJ starts from a starting point SP ahead of the behavior change point CP by a predetermined distance D1, turns right after passing through the behavior change point CP, and ends at an end point EP behind the behavior change point CP by a predetermined distance D3. The moving route TJ shifts to the right at a point ahead of the behavior change point CP by a predetermined distance D2.

The speed transition in the lower part of FIG. 5 is expressed on a two-dimensional coordinate system with a speed on a vertical axis and a route distance L measured from the starting point SP along the moving route TJ shown in the upper part of FIG. 5 on a horizontal axis. A curve shown in the lower part of FIG. 5 represents a speed transition VC. In the example illustrated, deceleration has already begun at the starting point SP, the speed decreases to reach a minimum speed, passing through the behavior change point CP immediately after acceleration begins, and constant speed movement begins right ahead the end point EP.

### 3. Location Prediction Device

The location prediction device 3 uses the behavior profile generated by the predictive data collection device 2 to predict a future location of a traffic participant TP which is about to pass through the behavior change point.

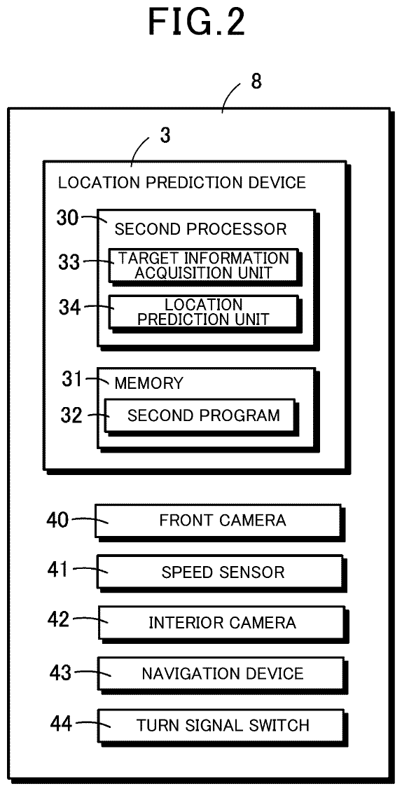

FIG. 2 is a diagram illustrating an example of the configuration of the location prediction device 3.

The location prediction device 3 is mounted on the own vehicle 8, which is a moving object ME.

The own vehicle 8 includes a front camera 40 that captures images of surroundings ahead in a traveling direction of the own vehicle 8, and a speed sensor 41 that detects a speed of the own vehicle 8. The own vehicle 8 may also include an interior camera 42 that captures images of an interior of the own vehicle 8, a navigation device 43 having a computer, and a turn signal switch 44 that turns on and off turn signal lamps.

The location prediction device 3 is a computer including a second processor 30 and a second memory 31. The second memory 31 may be configured by, for example, a volatile and/or non-volatile semiconductor memory. The second processor 30 is, for example, an arithmetic processing device such as a CPU. The second processor 30 may include a ROM in which a program is written, a RAM for temporarily storing data, and the like. The second processor 30 includes, as functional elements or functional units, a target information acquisition unit 33 and a location prediction unit 34.

These functional elements of the second processor 30 are implemented when the second processor 30 executes the second program 32 stored in the second memory 31, for example. The second program 32 can be stored in any computer-readable storage medium. Alternatively, all or some of the functional elements of the second processor 30 can be configured by hardware including one or more electronic circuit components.

The target information acquisition unit 33 acquires a current location and speed of a target participant, which is a traffic participant TP to be monitored. The target information acquisition unit 33 determines an attribute value of a participant attribute for the target participant.

The target participant includes at least the own vehicle 8, and may include a traffic participant TP present in front of the own vehicle 8. The traffic participant TP as the target participant may not be the traffic participant TP that is the learning participant determined by the predictive data collection device 2.

Specifically, the target information acquisition unit 33 fist detects a behavior change point ahead of the own vehicle 8 from a front image of the own vehicle 8 captured by the front camera 40. In other words, the target information acquisition unit 33 determines whether the behavior change point is present ahead of the own vehicle 8 from the front image of the own vehicle 8 captured by the front camera 40. Then, when the behavior change point is present, the target information acquisition unit 33 specifies a kind of the behavior change point from the front image and determines whether the own vehicle 8 is approaching the behavior change point. When the own vehicle 8 is approaching the behavior change point, the target information acquisition unit 33 acquires the current location and speed of the own vehicle 8 which is the target participant.

The current location of the own vehicle 8 can be calculated from the front image. The current location of the own vehicle 8 is, for example, a distance from the own vehicle 8 to the behavior change point and a relative location of the own vehicle 8 within the road width. The relative location is, for example, a distance from one of left and right lines defining the width of the road on which the own vehicle 8 is traveling. The speed of the own vehicle 8 can be acquired from the speed sensor 41 provided in the own vehicle 8.

In addition, the target information acquisition unit 33 specifies, from the front image, other traffic participants TP, which are approaching the detected behavior change point, as target participants, and acquires a current location and speed of each of the specified target participants. The current location of the target participant is, for example, a distance from the target participant to the behavior change point and a relative location of the target participant within the width of the road along which the target participant is moving. The relative location is, for example, a distance from one of left and right lines defining the width of the road along which the target participant is moving, as viewed from the target participant.

A location and speed of the target participant, which is a person P, can be acquired, for example, from the images captured by the front camera 40, or can be acquired based on images from the monitoring camera 5 when the location prediction device 3 is accessible to the monitoring camera 5. In addition, a location and speed of the target participant, which is a moving object ME, can be acquired, for example, from the images captured by the front camera 40, or can be acquired from the moving object ME when the location prediction device 3 can communicate with the moving object ME.

Alternatively, the location and speed of the target participant may be acquired from location information of a wearable device such as a smartphone owned by the target participant. Here, the “smartphone owned by the target participant” may be a smartphone owned by the person P when the target participant is the person P, and may be a smartphone owned by the occupant of the moving object ME when the target participant is the moving object ME. Alternatively, the location and speed of the target participant can be acquired from location information of a GPS or an inertial measurement unit provided in the moving object ME when the target participant is the moving object ME.

The target information acquisition unit 33 can acquire the location and speed of each of the target participants at a predetermined time interval, for example.

The target information acquisition unit 33 also acquires the attribute values of the participant attributes of each of the target participants approaching the detected behavior change point.

The attribute values of the own vehicle 8, which is a target participant, may be stored in advance in the second memory 31 when the location prediction device 3 is mounted on the own vehicle 8. The target information acquisition unit 33 can read out and acquire the attribute values of the own vehicle 8 from the second memory 31. Alternatively, when the moving object DB 7 is available, the target information acquisition unit 33 can obtain information regarding the own vehicle 8 from the moving object DB 7 based on the registration number of the own vehicle 8, and determine the attribute values of various participant attributes for the own vehicle 8. In addition, the target information acquisition unit 33 may determine the gender, the age, and the like of the driver of the own vehicle 8 from the image of the interior captured by the interior camera 42 provided in the own vehicle 8, and determine the attribute values for the participant attribute “classification” of the own vehicle 8.

The attribute values of the participant attributes for the traffic participant TP as the target participant can be acquired based on at least the front image captured by the front camera 40 of the own vehicle 8. The attribute values acquired from the front image may include at least attribute values of the participant attribute “type” and attribute values of the participant attribute “classification” such as the gender and age of the target participant, which is the person P. Alternatively, when the moving object DB 7 is available, the target information acquisition unit 33 can obtain information regarding the target participant, which is the moving object ME, from the moving object DB 7, and determine the attribute values of various participant attributes for such a target participant. In addition, when being accessible to the road management server 6, the target information acquisition unit 33 may acquire the attribute values of the target participant for the participant attribute “traffic environment” from the road management server 6.

The target information acquisition unit 33 also specifies a participant group corresponding to each of the target participants, from the attribute values of the participant attributes acquired for each of the target participants. Definition information of the participant group, that is, information regarding the combination of the attribute values that define each of the participant groups, can be stored in advance in the second memory 31, or can be acquired from the predictive data collection device 2 by the target information acquisition unit 33.

The target information acquisition unit 33 may also acquire information (referred to as suggestion information) that suggests a future trajectory of the target participant. As an example, the suggestion information may be information regarding suggestion behavior such as an action that the moving object ME turns on its turn signal or a gesture of raising a hand or pointing with a finger made by a person P (for example, a pedestrian or a cyclist), or information regarding route guidance in a navigation device provided in the moving object ME.

Alternatively, the suggestion information may use a past behavior history (for example, always turning right at the same intersection at the same time) of the target participant. For example, when the target participant is a moving object ME, the past behavior history of the target participant can be acquired from information regarding past route guidance stored in a navigation device provided in the moving object ME. Furthermore, when the target participant is a person P, the past behavior history of the target participant can be acquired from information regarding a movement history stored in a mobile terminal such as a smartphone owned by the person P.

The target information acquisition unit 33 can acquire the suggestion information regarding the own vehicle 8, which is the target participant, from the turn signal switch 44 and/or the navigation device 43. The target information acquisition unit 33 may also acquire the suggestion information regarding other target participants from the front image of the own vehicle 8 captured by the front camera 40.

The location prediction unit 34 applies the current location and speed of each of the target participants to the behavior profile calculated by the trajectory learning unit 24 of the predictive data collection device 2, and predicts a future location of each of the target participants.

In the present embodiment, particularly, the location prediction unit 34 predicts the future location of the target participant using the behavior profile of the participant group corresponding to the target participant, which is determined from the attribute values acquired for the target participant.

Thus, it is possible to predict the future location with high accuracy of the target participant using the behavior profile learned about the learning participant having the same attribute values as the attribute values of the target participant.

For example, the location prediction unit 34 can predict the future location of the target participant using a behavior profile including a combination of location and speed that most closely matches the combination of the current position and speed of the target participant, out of the behavior profiles of the participant group corresponding to the target participant. Thus, the behavior profile can be selected according to specific behavior changes, such as a right turn or a left turn at crossroads, from a behavior of the target participant in front of the crossroads, for example, whereby the future location of the target participant can be predicted with high accuracy.

Specifically, the location prediction unit 34 first downloads all or some of the behavior profiles stored in the behavior profile DB 4 and stores the downloaded behavior profiles in the second memory 31. The behavior profile can be downloaded to the second memory 31 at an appropriate timing, for example, at a start or end of a drive cycle of the own vehicle 8.

The location prediction unit 34 extracts a behavior profile associated with the participant group corresponding to the own vehicle 8 from the behavior profiles associated with the same kind as the kind of the behavior change point ahead of the own vehicle 8 specified by the target information acquisition unit 33. Then, the location prediction unit 34 applies the current location and speed of the own vehicle 8 specified by the target information acquisition unit 33 to the extracted behavior profile, and predicts the future location of the own vehicle 8 at a future time when a predetermined time has elapsed from now.

For example, the kind of the behavior change point ahead of the own vehicle 8 is a crossroads, the behavior profile extracted by the location prediction unit 34 may be three behavior profiles associated with combinations of the kind of the behavior change point “crossroads” and each of the three behavior contents “left turn”, “go straight”, and “right turn”. In addition, all the three behavior profiles are extracted from the behavior profile associated with the participant group corresponding to the own vehicle 8, as described above.

As an example, the location prediction unit 34 specifies a trajectory point located on each of the moving routes of the three behavior profiles and corresponding to the current location of the own vehicle 8. Next, the location prediction unit 34 acquires, as three trajectory speeds, the speeds corresponding to the specified trajectory points in each of the speed transition of the three behavior profiles. In addition, the location prediction unit 34 calculates three reciprocals of differences between the current speed of the own vehicle 8 and the three acquired trajectory speeds, and uses a ratio of the magnitude of each reciprocal to the sum of the three reciprocals as a probability (travel probability) that the own vehicle 8 travels along each of the three behavior profiles, the ratio being expressed as a percentage.

The travel probability may be calculated by any method without being limited to the above.

Then, the location prediction unit 34 uses speed transition data of the behavior profile that gives the highest travel probability to calculate the location of the own vehicle 8 at a future time after a predetermined time has elapsed from the current time when the own vehicle 8 travels along the speed transition, and sets the calculated location as a predicted future location of the own vehicle 8. Alternatively, the location prediction unit 34 may predict, based on a plurality of behavior profiles, a plurality of locations of the own vehicle 8 at a future time after a predetermined time has elapsed from the current time. Such plurality of locations may be a plurality of locations in which a matching probability with a future behavior of the own vehicle 8 is high, or may be positions predicted in branch directions of an intersection, for example.

In the behavior profile that gives the highest travel probability, when a difference between the speed corresponding to the specified trajectory point and the current speed of the own vehicle 8 is equal to or greater than a predetermined value, the location prediction unit 34 may predict the future location of the own vehicle 8 assuming that the own vehicle 8 travels according to a speed transition obtained by adding an offset equivalent to the speed difference to the speed transition of the behavior profile.

Alternatively, when predicting the future location, the location prediction unit 34 may take into consideration the speed difference between the current speed of the own vehicle 8 and the speed corresponding to the specified trajectory point, and calculate the future location as a location range of the own vehicle 8 at a future time when the speed of the own vehicle 8 changes within an error range of the speed difference along the speed transition of the behavior profile that gives the highest travel probability.

As the own vehicle 8 travels, the speed of the own vehicle 8 may change with a transition of time. The location prediction unit 34 repeatedly executes the above process based on the current location and speed of the own vehicle 8 acquired by the target information acquisition unit 33 at predetermined time intervals, and can predict the future location of the own vehicle 8 using the behavior profile with the highest travel probability at the current time.

Although the above description has been given as an example of a case where the behavior change point is the crossroads, the future location of the own vehicle 8 can be similarly predicted even in a case of other kinds of behavior change points. For example, when the behavior change point is a place where a temporary stop is defined, the location prediction unit 34 can extract two behavior profiles from the behavior profiles associated with the participant group corresponding to the own vehicle 8, the two behavior profiles being associated with two behavior contents at the temporary stop place including a case of passing through without stopping and a case of stopping. Then, the location prediction unit 34 can predict the future location of the own vehicle 8 using the behavior profile with the highest travel probability at the current time in the same manner as described above.

The location prediction unit 34 can also predict the future location of each of other target participants other than the own vehicle 8 in the same manner as described above.

Depending on the number of attribute values of the participant attributes capable of being acquired for each of the target participants by the target information acquisition unit 33, it may not be possible to narrow down the corresponding participant group to one for each of the target participants. In this case, the location prediction unit 34 may extract, for each of the target participants, a behavior profile associated with the same kind of behavior change point as the behavior change point ahead of the own vehicle 8, from all of the behavior profiles associated with each of the plurality of participant groups corresponding to the target participant. The location prediction unit 34 can predict the future location of the target participant using the behavior profile with the highest travel probability out of the extracted behavior profiles.

In the above example, as a behavior profile including the combination of location and speed that most closely matches the combination of the current position and speed of the target participant, out of the behavior profiles of the participant group corresponding to the target participant, a behavior profile having the largest reciprocal of the difference between the speed at the trajectory point corresponding to the current location of the target participant and the current speed of the target participant (that is, the behavior profile having the smallest difference in speed) out of behavior profiles being candidates is used.

Alternatively, the location prediction unit 34 may specify a speed point, which is a point on the speed transition corresponding to the current speed of the target participant, in each of a plurality of behavior profiles being candidates, and predict the future location of the target participant using the behavior profile having the largest reciprocal of the distance between the location of the trajectory point corresponding to the specified speed point and the current location of the target participant (that is, the behavior profile having the smallest difference in distance).

The location prediction unit 34 may predict the future location of the target participant based on the suggestion information suggesting the future trajectory of the target participant acquired by the target information acquisition unit 33 and the behavior profile of the participant group corresponding to the target participant.

For example, when the target information acquisition unit 33 acquires the information regarding turning-on of the turn signal, which suggests a right turn, as the suggestion information of the own vehicle 8 in front of the behavior change point which is a crossroads, the location prediction unit 34 can predict the future location of the own vehicle 8 using the behavior profile associated with the behavior change point “crossroads” and the behavior content “right turn” out of the behavior profiles associated with the participant group corresponding to the own vehicle 8. The future locations of other target participants can also be predicted in a similar manner.

The future location of the target participant predicted by the location prediction unit can be output to an assistance system (not illustrated) such as ADAS (Advanced Driver Assistance Systems) provided in the own vehicle 8, and can be reflected in execution of a driver assistance operation. Alternatively or additionally, the future location of the target participant predicted by the location prediction unit 34 may be output to the occupant of the own vehicle 8 as a display on a display device (not illustrated) provided in the own vehicle 8 or as sound from a speaker. The display could be provided as a display of the navigation device 43. Alternatively, when the own vehicle 8 is a motorcycle or a bicycle, the future location of the target participant predicted by the location prediction unit 34 may be output as a notification to a mobile terminal such as a smartphone carried by the driver of the own vehicle 8.

### 4. Operation of Location Prediction System

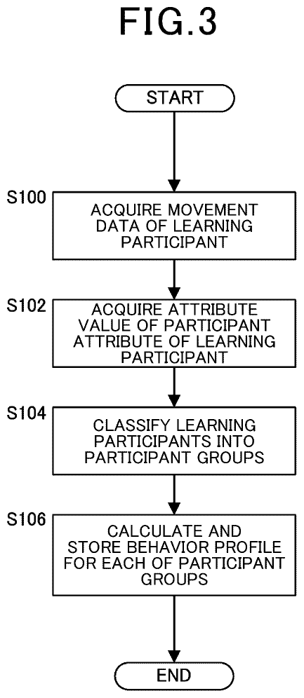

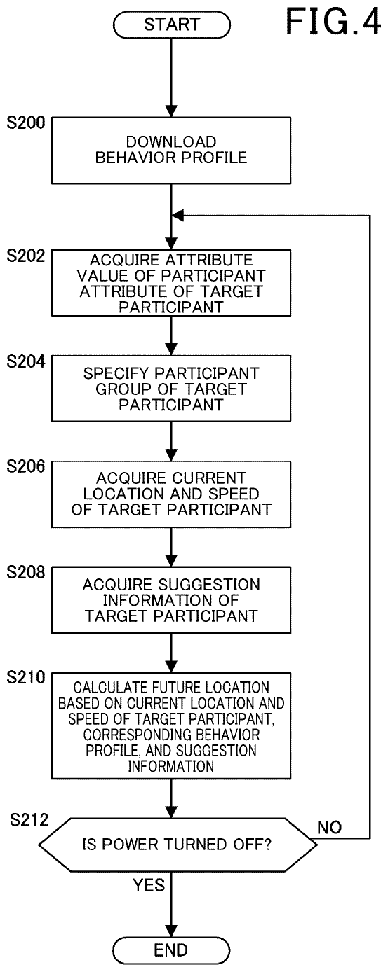

Next, a description will be given of a procedure of operation in the location prediction system 1. FIGS. 3 and 4 are flowcharts illustrating examples of a procedure of a location prediction method executed by the location prediction system 1. In the location prediction system 1, the predictive data collection device 2 and the location prediction device 3 cooperate with each other to execute the location prediction method. FIG. 3 is a flowchart illustrating a procedure of operation in the predictive data collection device 2, and FIG. 4 is a flowchart illustrating a procedure of operation in the location prediction device 3.

Processes illustrated in FIGS. 3 and 4 are executed by the first processor 20 of the predictive data collection device 2 and the second processor 30 of the location prediction device 3, the first processor 20 and the second processor 30 being computers, respectively.

First, the process in the predictive data collection device 2 illustrated in FIG. 3 will be described. The process illustrated in FIG. 3 starts when the predictive data collection device 2 is powered on, and is executed repeatedly. The process illustrated in FIG. 3 may start not only when the power of the predictive data collection device 2 is turned on, but also at an appropriate timing in a place where the behavior profile is not sufficiently collected in the behavior profile DB 4.

When the process starts, first, the learning information acquisition unit 23 of the predictive data collection device 2 acquires movement data, which is time series data of the location and speed, for at least one learning participant, which is the traffic participant TP to be learned (S100). At this time, the learning information acquisition unit 23 selects, based on the images from the monitoring camera 5, at least one or more traffic participant TP at various points (behavior change points) where the traffic participant TP may undergo some kinds of behavior change, as the learning participant.

In addition, the learning information acquisition unit 23 acquires attribute values of each of the learning participants with respect to the participant attributes determined in advance for the traffic participants (S102).

Next, the trajectory learning unit 24 of the predictive data collection device 2 classifies the learning participants into a plurality of participant groups based on the attribute values of the participant attributes (S104). For each of the participant groups, the trajectory learning unit 24 calculates a behavior profile including a moving route and a transition in speed along the moving route from movement data of the learning participants, stores the behavior profile in the behavior profile DB 4 (S106), and ends the process illustrated in FIG. 3. For example, the trajectory learning unit 24 calculates, for each kind of the behavior change point, a behavior profile including an average or representative moving route of the learning participant in each of the participant groups and a transition in average or representative speed along the moving route.

After the process in FIG. 3 ends, the learning information acquisition unit 23 starts a new process from step S100. A start timing of the new process may be, for example, a time when a predetermined period of time has elapsed after the process in FIG. 3 ends.

Next, a description will be given of the process in the location prediction device 3 illustrated in FIG. 4. The process illustrated in FIG. 4 starts when the location prediction device 3 is powered on.

When the process starts, the location prediction unit 34 of the location prediction device 3 downloads all behavior profiles stored in the behavior profile DB 4 from the behavior profile DB 4 and stores the behavior profiles in the second memory 31 (S200). Next, the target information acquisition unit 33 of the location prediction device 3 acquires attribute values of the participant attributes for each of the target participants (S202). In the present embodiment, the location prediction device 3 set, as the target participant, the own vehicle 8, which is the moving object ME on which the location prediction device 3 is mounted, and a traffic participant TP approaching a behavior change point present ahead of the own vehicle 8. As described above, the attribute values of the participant attributes of each of the target participants can be acquired from the images from the front camera 40 mounted on the own vehicle 8, the moving object DB 7, the road management server 6, and the like.

The target information acquisition unit 33 specifies, from the attribute values of the participant attributes acquired for each of the target participants, the participant group corresponding to each of the target participants (S204). Next, the target information acquisition unit 33 acquires a current location and a speed of each of the target participants (S206). As described above, the current location and the speed of each of the target participants can be acquired, for example, from the images from the front camera 40 mounted on the own vehicle 8, the speed sensor 41 mounted on the own vehicle 8, the monitoring camera 5, and/or the moving object ME which is the target participant.

Furthermore, when suggestion information suggesting a future trajectory of the target participant can be acquired from the target participant, the target information acquisition unit 33 acquires the suggestion information (S208). “When suggestion information suggesting a future trajectory of the target participant can be acquired” can be, for example, when the target participant performs the above-described suggestion behavior or when information regarding route guidance can be acquired from the navigation device of the moving object ME which is the target participant.

Next, for each of the target participants, the location prediction unit 34 predicts a future location of each of the target participants based on the current location and speed of the target participant, the behavior profile of the participant group corresponding to the target participant, and the suggestion information regarding the target participant (S210). Specifically, for each of the target participants, the location prediction unit 34 applies the current location and speed of the target participant to the behavior profile of the participant group corresponding to the target participant, and predicts the future location of each of the target participants. In addition, when the suggestion information is acquired for any one of the target participants in step S208, the behavior profile to be used can be selected in consideration of the suggestion information.

Next, the location prediction unit 34 determines whether the power of the location prediction device 3 is turned off (S212). Then, when the location prediction unit determines that the power of the location prediction device 3 is not turned off (S212, NO), the process returns to step S202. On the other hand, when the location prediction unit 34 determines that the power of the location prediction device 3 is turned off (S212, YES), the process in FIG. 4 ends.

In FIG. 3, steps S100 and S102 correspond to a learning information acquisition step in the present disclosure. In addition, steps S104 and S106 correspond to a trajectory learning step in the present disclosure.

In FIG. 4, at least step S206 corresponds to a target information acquisition step, and step S210 corresponds to a location prediction step.

### 5. Other Embodiments

In the above-described embodiment, the trajectory learning unit 24 of the predictive data collection device 2 stores and saves the calculated behavior profile in the behavior profile DB 4, in association with the combination of the kind of behavior change point and the content of the behavior change, and the identification information of the participant group. Alternatively or additionally, the trajectory learning unit 24 may store a “combination of a geographical location and kind of the behavior change point and the content of the behavior change” instead of the “combination of the kind of behavior change point and the content of the behavior change” in the behavior profile DB 4, in association with the behavior profile.

Thus, since a behavior of a traffic participant, which is characteristic of each of the behavior change points specified by the geographical location, can be learned, the accuracy of prediction of the future location using the behavior profile can be further improved. However, when a behavior profile is created that is not associated with the geographical location of the behavior change point but is associated with the “combination of the kind of behavior change point and the content of the behavior change”, there is an advantage in that the future location can be predicted with high accuracy using the behavior profile even in areas where maps are not modified.

In the above-described embodiment, the location prediction device 3 is provided in the own vehicle 8, which is the moving object ME, but the location prediction device 3 may also be configured as a server device connected to the communication network NW. For example, the location prediction device 3 configured as the server device server device may use the monitoring camera 5 to predict the future location of each of the target participants which is any traffic participant TP passing through a predetermined behavior change point. The prediction results of these future locations can be transmitted, for example, from the location prediction device 3 to the moving object ME passing through the behavior change point, and used to assist the driver of the moving object ME.

In the above-described embodiment, the process in the location prediction device 3 illustrated in FIG. 4 starts when the power of the location prediction device 3 is turned on. However, without being limited to such a case, the process in the location prediction device 3 illustrated in FIG. 4 may start in a situation, in which a risk is predicted for the own vehicle 8. For example, the own vehicle 8 may include a risk determination unit that detects a situation in which a risk is predicted for the own vehicle 8, and may instruct the location prediction device 3 to execute the process illustrated in FIG. 4 when the risk determination unit predicts a risk. The risk determination unit can be configured to determine that a risk is predicted for the own vehicle 8, for example, when another traffic participant TP or an obstacle approaching the own vehicle 8 is detected or when the own vehicle 8 enters an intersection.

The present invention is not limited to the configuration of the above-described embodiment, and can be implemented in various forms without departing from the gist of the present invention.

### 6. Configurations Supported By Embodiment Described Above

The above-described embodiment supports the following configurations.

### (Configuration 1)

A location prediction system including: a learning information acquisition unit that acquires movement data, which is time series data of location and speed, of at least one of learning participants, which is a traffic participant to be learned; a trajectory learning unit that calculates, from the movement data of the learning participant, a behavior profile including a moving route and a transition in speed along the moving route and stores the behavior profile; a target information acquisition unit that acquires a current location and speed of a target participant, which is a traffic participant to be monitored; and a location prediction unit that applies the current location and speed of the target participant to the behavior profile and predicts a future location of the target participant, the learning information acquisition unit being configured to acquire an attribute value of each of the learning participants with respect to a participant attribute determined in advance for the traffic participant, the trajectory learning unit being configured to classify the learning participants into a plurality of participant groups based on the attribute value, and calculate and store the behavior profile for each of the participant groups.

According to the location prediction system of Configuration 1, a movement aspect according to the attribute of the traffic participant is learned as the behavior profile, and the future location of the traffic participant is predicted using the learned behavior profile, whereby the future location can be predicted with high accuracy.

### (Configuration 2)

In the location prediction system according to Configuration 1, the target information acquisition unit acquires an attribute value of the participant attribute for the target participant, and specifies the participant group corresponding to the target participant from the attribute value for the target participant, and the location prediction unit predicts a future location of the target participant using the behavior profile for the participant group corresponding to the target participant.

According to the location prediction system of Configuration 2, the future location of the target participant is predicted using the behavior profile learned about the learning participant having the same attribute values as the attribute values of the target participant, whereby the future location can be predicted with high accuracy.

### (Configuration 3)

In the location prediction system according to Configuration 1 or 2, the location prediction unit predicts a future location of the target participant using the behavior profile including a combination of location and speed that most closely matches a combination of the current position and speed of the target participant.

According to the location prediction system of Configuration 3, the behavior profile can be selected according to a specific behavior change such as a right turn or a left turn at crossroads, from the behavior of the target participant in front of the crossroads, for example, whereby the future location of the target participant can be predicted with higher accuracy.

### (Configuration 4)

In the location prediction system according to any one of Configurations 1 to 3, the target information acquisition unit acquires suggestion information that suggests a future trajectory of the target participant, and the location prediction unit predicts a future location of the target participant based on the suggestion information and the behavior profile of the participant group corresponding to the target participant.

According to the location prediction system of Configuration 4, the suggestion information suggesting the future trajectory is also used, whereby the future location of the target participant can be predicted early with high accuracy.

### (Configuration 5)

In the location prediction system according to any one of Configurations 1 to 4, the participant attribute includes a type of the traffic participant.

According to the location prediction system of Configuration 5, the behavior profile can be created according to the type of the traffic participant such as a person, a two-wheeled vehicle, or a four-wheeled vehicle, whereby it is possible to predict the future location, in which the behavior aspect is reflected according to the kind of the target participant, with high accuracy.

### (Configuration 6)

In the location prediction system according to any one of Configurations 1 to 5, the participant attribute includes a behavior tendency of the traffic participant.

According to the location prediction system of Configuration 6, the future location of the target participant can be predicted with high accuracy in consideration of the behavior tendency of the pedestrian and the behavior tendency of the driver of the moving object.

### (Configuration 7)

In the location prediction system according to any one of Configurations 1 to 6, the participant attribute includes a detail related to a traffic environment of a place where the traffic participant moves.

According to the location prediction system of Configuration 7, the future location of the target participant can be predicted with high accuracy in consideration of the influence of traffic conditions such as congestion, and weather on the behavior of the traffic participant.

### (Configuration 8)

A location prediction method executed by a computer, the method including: a learning information acquisition step of acquiring movement data, which is time series data of location and speed, for at least one of learning participants, which is a traffic participant to be learned; a trajectory learning step of calculating, from the movement data of the learning participant, a behavior profile including a moving route and a transition in speed along the moving route and storing the behavior profile; a target information acquisition step of acquiring a current location and speed of a target participant, which is a traffic participant to be monitored; and a location prediction step of applying the current location and speed of the target participant to the behavior profile and predicting a future location of the target participant, the learning information acquisition step including acquiring an attribute value of each of the learning participants with respect to a participant attribute determined in advance for the traffic participant, the trajectory learning step including classifying the learning participants into a plurality of participant groups based on the attribute value, and calculating and storing the behavior profile for each of the participant groups.

According to the location prediction method of Configuration 8, the same effects as those of the location prediction system of Configuration 1 are obtained.

### (Configuration 9)

A predictive data collection device including: a learning information acquisition unit that acquires movement data, which is time series data of location and speed, of at least one of learning participants, which is a traffic participant to be learned; and a trajectory learning unit that calculates, from the movement data of the learning participant, a behavior profile including a moving route and a transition in speed along the moving route and stores the behavior profile, the learning information acquisition unit being configured to acquire an attribute value of each of the learning participants with respect to a participant attribute determined in advance for the traffic participant, the trajectory learning unit being configured to classify the learning participants into a plurality of participant groups based on the attribute value, and calculate and store the behavior profile for each of the participant groups.

According to the predictive data collection device of Configuration 9, it is possible to generate and provide the behavior profile that reflects the movement aspect according to the attribute of the traffic participant to enable the future location prediction of the traffic participant with high accuracy.

### (Configuration 10)

A location prediction device including: a target information acquisition unit that acquires a current location and speed of a target participant, which is a traffic participant to be monitored; and a location prediction unit that uses a behavior profile calculated from time series data of location and speed of at least one of learning participants, which is a traffic participant to be learned, applies the current location and speed of the target participant to the behavior profile, and predicts a future location of the target participant, the behavior profile including a moving route and a transition in speed along the moving route, the behavior profile being created for each participant group of the learning participants classified by an attribute value of a participant attribute determined in advance, the target information acquisition unit being configured to acquire an attribute value of the participant attribute for the target participant, and specify the participant group corresponding to the target participant from the attribute value for the target participant, and the location prediction unit being configured to predict a future location of the target participant using the behavior profile for the participant group corresponding to the target participant.

According to the location prediction device of Configuration 10, the future location of the target participant is predicted using the behavior profile learned about the learning participant having the same attribute values as the attribute values of the target participant, whereby the future location can be predicted with high accuracy.

### REFERENCE SIGNS LIST

1 location prediction system, 2 predictive data collection device, 3 location prediction device, 4 behavior profile DB, 5 monitoring camera, 6 road management server, 7 moving object DB, 8 own vehicle, 20 first processor, 21 first memory, 22 first program, 23 learning information acquisition unit, 24 trajectory learning unit, 30 second processor, 31 second memory, 32 second program, 33 target information acquisition unit, 34 location prediction unit, 40 front camera, 41 speed sensor, 42 interior camera, 43 navigation device, 44 turn signal switch, CP behavior change point, EP end point, L route distance, ME moving object, NW communication network, P person, SP starting point, TJ moving route, TP traffic participant, VC speed transition.

1. A location prediction system comprising:
a learning information acquisition unit that acquires movement data, which is time series data of location and speed, of at least one of learning participants, which is a traffic participant to be learned;
a trajectory learning unit that calculates, from the movement data of the learning participant, a behavior profile including a moving route and a transition in speed along the moving route and stores the behavior profile;
a target information acquisition unit that acquires a current location and speed of a target participant, which is a traffic participant to be monitored; and
a location prediction unit that applies the current location and speed of the target participant to the behavior profile and predicts a future location of the target participant,
the learning information acquisition unit being configured to acquire an attribute value of each of the learning participants with respect to a participant attribute determined in advance for the traffic participant,
the trajectory learning unit being configured to classify the learning participants into a plurality of participant groups based on the attribute value, and calculate and store the behavior profile for each of the participant groups.

2. The location prediction system according to claim 1, wherein
the target information acquisition unit acquires an attribute value of the participant attribute for the target participant, and specifies the participant group corresponding to the target participant from the attribute value for the target participant, and
the location prediction unit predicts a future location of the target participant using the behavior profile for the participant group corresponding to the target participant.

3. The location prediction system according to claim 1, wherein
the location prediction unit predicts a future location of the target participant using the behavior profile including a combination of location and speed that most closely matches a combination of the current position and speed of the target participant.

4. The location prediction system according to claim 1, wherein
the target information acquisition unit acquires suggestion information that suggests a future trajectory of the target participant, and
the location prediction unit predicts a future location of the target participant based on the suggestion information and the behavior profile of the participant group corresponding to the target participant.

5. The location prediction system according to claim 1, wherein
the participant attribute includes a type of the traffic participant.

6. The location prediction system according to claim 1, wherein
the participant attribute includes a behavior tendency of the traffic participant.

7. The location prediction system according to claim 1, wherein
the participant attribute includes a detail related to a traffic environment of a place where the traffic participant moves.

8. A location prediction method executed by a computer, the method comprising:
a learning information acquisition step of acquiring movement data, which is time series data of location and speed, for at least one of learning participants, which is a traffic participant to be learned;
a trajectory learning step of calculating, from the movement data of the learning participant, a behavior profile including a moving route and a transition in speed along the moving route and storing the behavior profile;
a target information acquisition step of acquiring a current location and speed of a target participant, which is a traffic participant to be monitored; and
a location prediction step of applying the current location and speed of the target participant to the behavior profile and predicting a future location of the target participant,
the learning information acquisition step including acquiring an attribute value of each of the learning participants with respect to a participant attribute determined in advance for the traffic participant,
the trajectory learning step including classifying the learning participants into a plurality of participant groups based on the attribute value, and calculating and storing the behavior profile for each of the participant groups.

9. A predictive data collection device comprising:
a learning information acquisition unit that acquires movement data, which is time series data of location and speed, of at least one of learning participants, which is a traffic participant to be learned; and
a trajectory learning unit that calculates, from the movement data of the learning participant, a behavior profile including a moving route and a transition in speed along the moving route and stores the behavior profile,
the learning information acquisition unit being configured to acquire an attribute value of each of the learning participants with respect to a participant attribute determined in advance for the traffic participant,
the trajectory learning unit being configured to classify the learning participants into a plurality of participant groups based on the attribute value, and calculate and store the behavior profile for each of the participant groups.

10. A location prediction device comprising:
a target information acquisition unit that acquires a current location and speed of a target participant, which is a traffic participant to be monitored; and
a location prediction unit that uses a behavior profile calculated from time series data of location and speed of at least one of learning participants, which is a traffic participant to be learned, applies the current location and speed of the target participant to the behavior profile, and predicts a future location of the target participant, the behavior profile including a moving route and a transition in speed along the moving route,
the behavior profile being created for each participant group of the learning participants classified by an attribute value of a participant attribute determined in advance,
the target information acquisition unit being configured to acquire an attribute value of the participant attribute for the target participant, and specify the participant group corresponding to the target participant from the attribute value for the target participant, and
the location prediction unit being configured to predict a future location of the target participant using the behavior profile for the participant group corresponding to the target participant.
